(19) United States
(12) Patent Application Publication
(10) Pub. No.: US 2015/0286043 A1
(43) Pub. Date: Oct. 8, 2015

(54) ANNULAR ILLUMINATION STRUCTURE

(71) Applicant: Bio-Rad Laboratories, Inc., Hercules, CA (US)

(72) Inventor: NICHOLAS DOE, SAN RAMON, CA (US)

(73) Assignee: Bio-Rad Laboratories, Inc., Hercules, CA (US)

(21) Appl. No.: 14/674,520

(22) Filed: Mar. 31, 2015

Related U.S. Application Data
(60) Provisional application No. 61/975,638, filed on Apr. 4, 2014.

(51) Int. Cl. G02B 21/08; G02B 21/36

(52) U.S. Cl. CPC G02B 21/084; G02B 21/367; G02B 21/361

(57) ABSTRACT

The present invention relates in general to microscopy systems and the illumination of target regions of the microscopy system with an annular illumination structure. The annular illumination structure can partially illuminate by quadrant, and can include a plurality of LEDs as light sources located in the annular structure that surround the lens or camera of an optical imaging and capture system.

### CROSS-REFERENCE TO RELATED APPLICATIONS

This application claims priority to and the benefit of U.S. Provisional Patent Application No. 61/975,638, entitled “ANNULAR ILLUMINATION STRUCTURE,” filed Apr. 4, 2014, the disclosure of which is hereby incorporated by reference.

### FIELD OF THE INVENTION

The present invention relates in general to microscopy systems. In particular, the present invention relates to an illumination source for microscopy systems.

### BACKGROUND OF THE INVENTION

Microscopy is an essential tool to researchers across the entire life science field. Several imaging modes are used in conventional, non-fluorescence microscopy, typically bright field, dark field, polarization, and various phase contrast techniques. In particular, biological samples typically have low amplitude contrast, and can require some form of phase contrast to accurately and precisely view and image the biological samples.

### SUMMARY OF THE INVENTION

The following presents a simplified summary of some embodiments of the invention in order to provide a basic understanding of the invention. This summary is not an extensive overview of the invention. It is not intended to identify key or critical elements of the invention or to delineate the scope of the invention. Its sole purpose is to present some embodiments of the invention in a simplified form as a prelude to the more detailed description that is presented later.

In some embodiments and aspects, the disclosed annular light source and microscopy camera assembly can include an annular ring having an interior circumference and an exterior circumference, at least one light source disposed in the annular ring between the interior circumference and the exterior circumference, a camera for orienting the desired location of the sample, positioned within interior circumference of the annular ring and directed toward a target region, a diffuser structure, positioned proximate to the plurality of light sources and between the plurality of light sources and the target region, such that illumination from the plurality of light sources passes through the diffuser structure before illuminating the target region, and a microscopy camera positioned to capture an image of the target region illuminated by light that passes through the diffuser structure. In some aspects, the annular light source and microscopy camera assembly can further include at least one light source is a plurality of LEDs. In other aspects, the annular light source and microscopy camera assembly can have a plurality of LEDs that are warm white LEDs, while in other aspects the plurality of LEDs can be green LEDs, and in further aspects, the plurality of LEDs can emit light in a narrow band of wavelengths. In some aspects, the microscopy camera can be positioned on a side of the target region opposite from the annular ring and diffuser structure. In further aspects, the annular light source and microscopy camera assembly can have a plurality of light sources in the annular ring that are configured to be controllable according to which quadrant in the annular ring the plurality of light sources are disposed. In some aspects, the annular light source and microscopy camera assembly does not include a condenser lens. In yet other aspects, the annular light source and microscopy camera assembly can have an annular ring that includes at least one independently controllable light source in each quadrant of the annular ring. In further aspects, the annular light source and microscopy camera assembly can have an adjustable z-distance between the annular ring and the target region.

In other embodiments and aspects, the disclosed annular light source and microscopy camera assembly can include an annular ring having an interior circumference and an exterior circumference, a plurality of LEDs disposed in the annular ring between the interior circumference and the exterior circumference, an orientation camera, positioned within interior circumference of the annular ring and directed toward a target region, and a microscopy camera positioned to capture an image of the target region illuminated by light emitted from the plurality of LEDs. In some aspects, the annular light source and microscopy camera assembly can have a plurality of LEDs that are warm white LEDs, while in other aspects, the plurality of LEDs can be green LEDs. In further aspects, the annular light source and microscopy camera assembly can further include a diffuser structure, positioned proximate to the plurality of light sources and between the plurality of light sources and the target region, such that illumination from the plurality of light sources passes through the diffuser structure before illuminating the target region. In other aspects, the annular light source and microscopy camera assembly can have an annular ring that includes at least one independently controllable LED in each quadrant of the annular ring. In some aspects, the annular light source and microscopy camera does not include a condenser lens. In other aspects, the microscopy camera can be positioned on a side of the target region opposite from the annular ring. In yet other aspects, the annular light source and microscopy camera assembly can have an adjustable z-distance between the annular ring and the target region.

In further aspects, the disclosed annular light source and microscopy camera assembly can include a method of application including providing an annular structure, having a plurality of light sources disposed between an interior circumference and an exterior circumference of the annular structure, proximate to a target region, instructing at least one of the plurality of light sources to illuminate, and transmitting light through a diffuser structure onto the target region from light sources on one side of the annular ring and is of a narrow band of wavelengths. In some aspects, the method of illuminating a target region in a microscopy camera assembly further includes, where the plurality of light sources are individually controllable within each quadrant of the annular structure, the instructing of at least one of the plurality of light sources to illuminate includes instructing only one quadrant of the plurality of light sources to illuminate. In other aspects, the method of illuminating a target region in a microscopy camera assembly includes, where the plurality of light sources are individually controllable within each quadrant of the annular structure, the instructing at least one of the plurality of light sources to illuminate includes instructing two adjacent quadrants of the plurality of light sources to illuminate. In yet other aspects, the method of illuminating a target region in a microscopy camera assembly can include adjusting the z-distance between the annular structure and the target region. In some aspects, the method includes illuminating with the plurality of light sources, where the plurality of light sources activated are biased to emit from light sources on one side of the annular ring. In some aspects, the method includes illuminating with the plurality of light sources, where the plurality of light sources activated emit light in a narrow band of wavelengths. In some aspects, the method includes illuminating with the plurality of light sources, where the plurality of light sources activated are biased to emit from light sources on one side of the annular ring and/or in a narrow band of wavelengths.

### BRIEF DESCRIPTION OF THE DRAWINGS

Illustrative aspects of the present disclosure are described in detail below with reference to the following drawing figures.

FIG. 1 shows a schematic representation of a circular annular illumination structure, according to an embodiment.

FIG. 2 shows a schematic representation of an elliptical annular illumination structure, according to an embodiment.

FIG. 3A shows a schematic cross-sectional representation of a microscopy system configured to have an annular illumination structure, a diffuser, and a target region, according to an embodiment.

FIG. 3B shows a schematic representation of a microscopy system configured to have an annular illumination structure, a diffuser, a target region, objective lens, and microscope camera, according to an embodiment.

FIG. 4A shows an exemplary image of a sample illuminated by warm white light, according to an embodiment.

FIG. 4B shows an exemplary image of a sample illuminated by warm white light biased from the left side of the sample, according to an embodiment.

FIG. 5A shows an exemplary zoomed-in image of a sample illuminated by warm white light at full illumination, according to an embodiment.

FIG. 5B shows an exemplary zoomed-in image of a sample illuminated by warm white light biased from the left side of the sample, according to an embodiment.

FIG. 6A shows an exemplary image of a sample illuminated by warm white light using a bright focus, according to an embodiment.

FIG. 6B shows an exemplary image of a sample illuminated by warm white light biased from the left side of the sample, according to an embodiment.

FIG. 7A shows an exemplary image of a sample illuminated by white light, according to an embodiment.

FIG. 7B shows an exemplary image of a sample illuminated by green light, according to an embodiment.

FIG. 8A shows an exemplary image of a sample illuminated by green light biased from the right side of the sample, according to an embodiment.

FIG. 8B shows an exemplary image of a sample illuminated by green light biased from the left side of the sample, according to an embodiment.

FIG. 9 shows a schematic representation of a microscopy system configured to have a condenser lens.

### DETAILED DESCRIPTION

Throughout this description for the purposes of explanation, numerous specific details are set forth in order to provide a thorough understanding of the present disclosure. It will be apparent, however, to one skilled in the art that the present disclosure may be practiced without some of these specific details. In other instances, structures and devices are shown in schematic form to avoid obscuring the underlying principles of the described embodiments.

The present invention relates to microscopes and the illumination of samples viewed and imaged by microscopes. Further, the present invention relates to the color, intensity, direction, and other aspects of a light source configuration for illuminating a sample viewed by a microscope.

Cameras, as used in microscopy systems, have aperture characteristics which in part defines the size and resolution of the images that are viewed and captured by such cameras. The aperture cone (in other words, the area of visualization) for any given camera requires illumination. A condenser lens or condenser illuminator can function to direct a cone of light that can overlay the aperture cone, providing the illumination needed for the viewing region. In many applications, this illumination is transmissive illumination, where light cast on a sample or target region that will transmit or refract though, or reflect from the sample or target region and be captured by the optical system of an objective camera. However, condenser lenses can add complexity, size, and cost to a microscopy system and thereby reduce the functionality of the microscopy system.

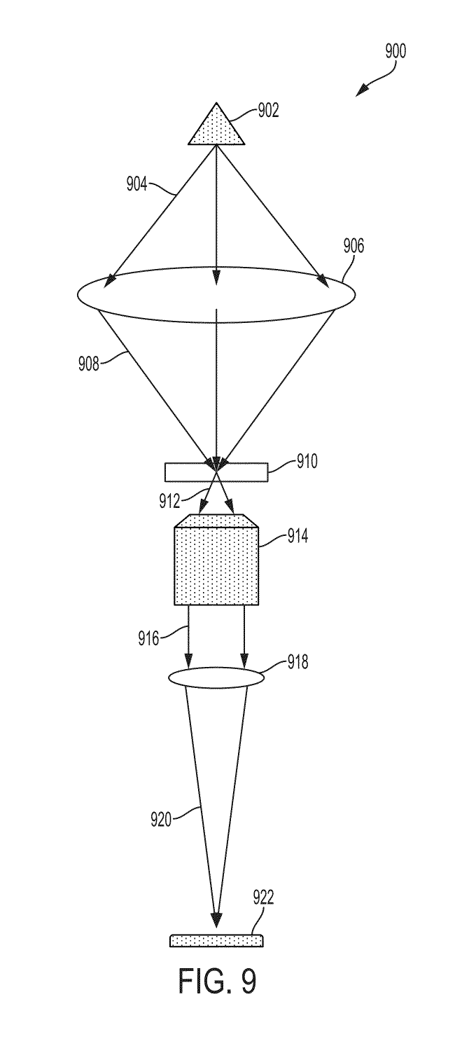

As seen in FIG. 9, a microscopy system 900 as known in the art can typically include a condenser lens. Specifically, a light source 902 can cast initial light 904 which a condenser lens 906, placed in the optical path of the initial light 904, can focus. The focused light 908 is directed by the condenser lens 906 toward a target region 910, which in microscopy systems can hold a sample. The transmissive light 912 that passes through the target region 910 and any sample therein can pass into a microscope objective lens 914, which can focus the light rays to produce real image light 916. The real image light 916 can further pass through a tube lens 918, thereby passing focused real image light 920 onto a microscope camera 922 that captures the image of a sample in the target region 910. A microscopy system without a condenser lens 906 can be less complex and have a more convenient form factor due to a reduced size of the overall system.

In embodiments of the microscopy system disclosed herein, an annulus (e.g. a ring, a circle, an ellipse, etc.) of light emitting diodes (LEDs) can be used as an illumination source in place of a conventional condenser lens or condenser illuminator. Optionally, an orientation camera can be located within the inner diameter of the annulus, such as in the center of the annulus. In addition to the annulus' contribution to improved contrast, the aperture cone of the camera can be illuminated by the LEDs, or other such plurality of light sources. In other words, the geometry of the annular ring can be such that the illumination falls within the acceptance angle (NA) of the objective lens. The interior and exterior circumferences, or inner and outer diameters, of the annulus are chosen to obtain phase imaging performance with desired precision and resolution. In a microscopy system, the light cast by the light sources disposed within the annular ring is directed toward a sample or a target region held or located within the system. The use of an annular illumination source can achieve desirable bright field performance, without a condenser lens, by filling a sufficient percentage of the angular acceptance of an objective lens using an even distribution illumination source.

In aspects, an annular illumination source as disclosed herein can cast light beyond the scope of the aperture cone of a camera, illuminating a wider area than necessary for the resolution of the camera. In such cases, dark field imaging can be achieved if the ring is outside the acceptance angle, and can be used as a distinct imaging mode.

In alternative embodiments, the annulus can have a single, annular light source. In all such embodiments, the annulus has at least one light source. In further alternative embodiments, more than one annular illumination source can be proximate to a camera and illuminate the aperture cone of the camera. In such embodiments, the more than one annular illumination sources can be arranged proximate, distal, or concentric to each other.

Microscopy systems as known in the art can also be subject to “dark focus” and “bright focus” effects that can complicate the viewing and imaging of biological samples. In particular, the viewing of biological samples such as cells, or other such “phase objects” with a microscope can be complicated in that the illuminated phase object does not necessarily come into focus when an microscope is adjusted to the correct focal position where the phase object is located in a sample. The phase object can appear dark when the microscope is adjusted to view on one side of the correct focal point, which can be referred to as the “dark side of focus”. Further, the phase object, can appear faded or “washed out” when the microscope is adjusted to view at the correct focal point (when the phase object is technically in focus), which can be in part due to the illumination of the phase object. The phase object, however, can be more clearly visualized and appear bright when the microscope is adjusted to view past the correct focal point, which can be referred to as the “bright side of focus” (when the microscope is adjusted to view the side opposite from the dark side of focus). Accordingly, in some systems, a phase object can only be visualized when the microscope is on the bright side of focus, which means the phase object is not properly in focus and subjected to an overexposure of light.

In embodiments, the annulus can be divided into a number of sections which are independently controlled by the user. In some aspects, the light sources in the annulus can be controllable along two axes quartering the annulus. Accordingly, this provides for annular, semicircular, or quadrant illumination. The partial or biased illumination of the light source can mitigate the dark focus and bright focus effects seen in other microscopy systems. With partial or biased illumination, a cell or other such phase object can be visualized by a microscope when adjusted to the correct focal point corresponding to the location of the cell or phase object in a sample. The partial or biased illumination can be controlled with a user input device coupled with a non-transitory, computer-readable medium, electronically coupled to the illumination source.

In embodiments, a light diffuser can be placed proximate to and in front of the LED illumination source, forcing light from the illumination source to pass through the diffuser, to thereby generate illumination having an even or uniform distribution. The diffuser structure being proximate to an illumination source, can be adjacent to, in direct contact with, or specifically spaced from the illumination source. This is distinct from conventional LED illuminators, where each LED can produce an individual bright spot, and therefore can produce individual shadows or uneven illumination (e.g. a multi-shadow effect resulting from the aggregation of shadows from each point light source) which may reduce the quality, resolution, or accuracy of the imaged region. The diffuser can provide for a more uniform illumination, where in some aspects, visual artifacts can be characterized by an acceptable halo or semicircular effect. In some aspects, the LED illumination source can be a one color LED source, a multi-color LED source, or a white light LED source. In other aspects, the white light LED source can be a white LED light having a relatively low color temperature, which can be referred to as a “warm white” LED (and can be characterized as being “soft” light). In further aspects, a white or colored LED source can have a relatively high color temperature.

A diffuser, as used herein, refers to an optical device that diffuses, spreads out, or scatters light, such that the light that passes through the diffuser is soft light, and in aspects has the characteristics of a light source that is large relative to the size of the target region or subject illuminated by the diffused light. In aspects, a diffuser can be a translucent object, opaque glass, greyed glass, opal glass, ground glass, or other such structure made of a material that can diffuse light with a uniform and even distribution.

As discussed below, it has been discovered that light of a relatively narrow band of wavelengths can in some embodiments improve contrast. A narrow band of wavelengths can be, for example, less than 100 nm wide, e.g., between 10-100 nm. In some embodiments, the wavelength is primarily one color (e.g., red, blue, green). The narrow band of wavelengths can be achieved by providing colored LED illumination in the annulus, or by using wavelength filters such that white light from the illumination source is filtered such that only a narrow band of wavelengths are available to the sample. In some aspects, the LED illumination source can be a plurality of green LEDs, being a plurality of LEDs emitting light having a wavelength (X) in the range of about 495 nm to about 570 nm. In other embodiments, the LED illumination source can be a plurality of red light LEDs, a plurality of orange light LEDs, a plurality of yellow light LEDs, a plurality of blue light LEDs, a plurality of purple light LEDs, or a plurality of multi-colored LEDs.

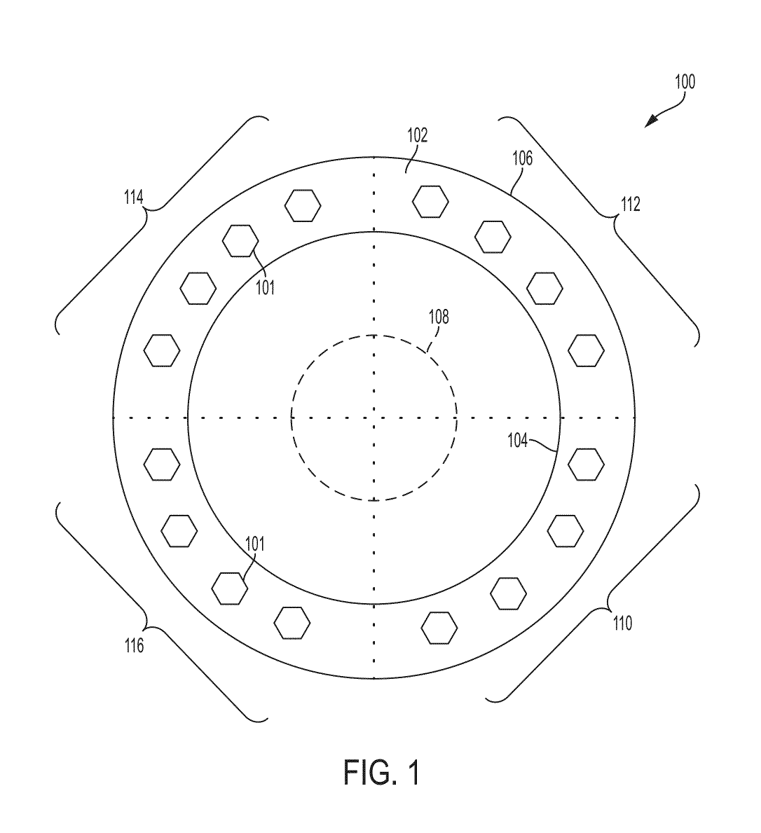

FIG. 1 shows a schematic representation of a circular annular illumination structure 100. The circular annular ring 102 is defined by an interior circumference 104 and an exterior circumference 106. In aspects, the interior circumference 104 and exterior circumference 106 can be defined as a first and a second circumference, or defined by a first and second diameter, or by a first and a second radius. The light source 101 of the circular annular illumination structure 100 is located in the circular annular ring 102, where in some aspects the light sources 101 can be a plurality of LEDs. In some embodiments, the circular annular ring 102 is centered around a camera 108, optionally where the visualization cone defined by the aperture of the camera 108 can be illuminated by light sources 101 residing in the circular annular ring 102. In an exemplary embodiment, the circular annular ring 102 can have an interior circumference 104 with a 25 mm diameter and an exterior circumference with a 43 mm diameter. In another exemplary embodiment, the circular annular ring 102 can have an interior circumference 104 with a 18 mm diameter and an exterior circumference with a 43 mm diameter. In yet another exemplary embodiment, the circular annular ring 102 can have an interior circumference 104 with a 25 mm diameter and an exterior circumference with a 50 mm diameter. In various aspects the circular annular ring 102 can have an interior circumference 104 with a diameter of about 15 mm to about 30 mm, and an exterior circumference with a diameter of about 35 mm to about 55 mm.

As discussed herein, in some aspects, light bias from a side of the annulus ring (rather than from the entire annulus ring) can improve contrast. Light bias can be achieved in numerous configurations. In some embodiments, the light sources 101 in the circular annular ring 102 can be controlled in sections, defined by axes quartering the circular annular illumination structure 100. In aspects, the circular annular ring 102 can be divided into a first quadrant 110, a second quadrant 112, a third quadrant 114, and a fourth quadrant 116. The light sources 101 residing in the circular annular ring 102 can be independently controlled according to the quadrant in which the light sources 101 are located. Accordingly, in some aspects, light sources 101 in the first quadrant 110 can be set or powered to illuminate while the light sources 101 in the remaining quadrants are turned off and do not illuminate. In other aspects, light sources 101 in the second quadrant 112 can be set or powered to illuminate while the light sources 101 in the remaining quadrants are turned off and do not illuminate. In other aspects, light sources 101 in the third quadrant 114 can be set or powered to illuminate while the light sources 101 in the remaining quadrants are turned off and do not illuminate. In other aspects, light sources 101 in the fourth quadrant 116 can be set or powered to illuminate while the light sources 101 in the remaining quadrants are turned off and do not illuminate. Such aspects allow for the illumination from the circular annular ring 102 to be biased from one quadrant of the circular annular ring 102.

The some aspects, light sources 101 in two quadrants of the circular annular ring 102 can be turned on or powered to cast light and illuminate, where two adjacent quadrants that illuminate simultaneously allow for the illumination from the circular annular ring 102 to be biased from one half or one side of the circular annular ring 102. In some aspects, light sources 101 in the first quadrant 110 and second quadrant 112 can be set or powered to illuminate while the light sources 101 in the remaining quadrants are turned off and do not illuminate. In some aspects, light sources 101 in the first quadrant 110 and fourth quadrant 116 can be set or powered to illuminate while the light sources 101 in the remaining quadrants are turned off and do not illuminate. In some aspects, light sources 101 in the second quadrant 112 and third quadrant 114 can be set or powered to illuminate while the light sources 101 in the remaining quadrants are turned off and do not illuminate. In some aspects, light sources 101 in the third quadrant 114 and fourth quadrant 116 can be set or powered to illuminate while the light sources 101 in the remaining quadrants are turned off and do not illuminate.

In other aspects, three of the four quadrants of light sources 101 in the circular annular ring 102 can be illuminated simultaneously. In still other aspects, two opposing quadrants of light sources 101 in the circular annular ring 102 can be illuminated simultaneously (e.g.

illuminating the first quadrant 110 and the third quadrant 114). In further aspects, all four quadrants of light sources 101 in the circular annular ring 102 can illuminate simultaneously.

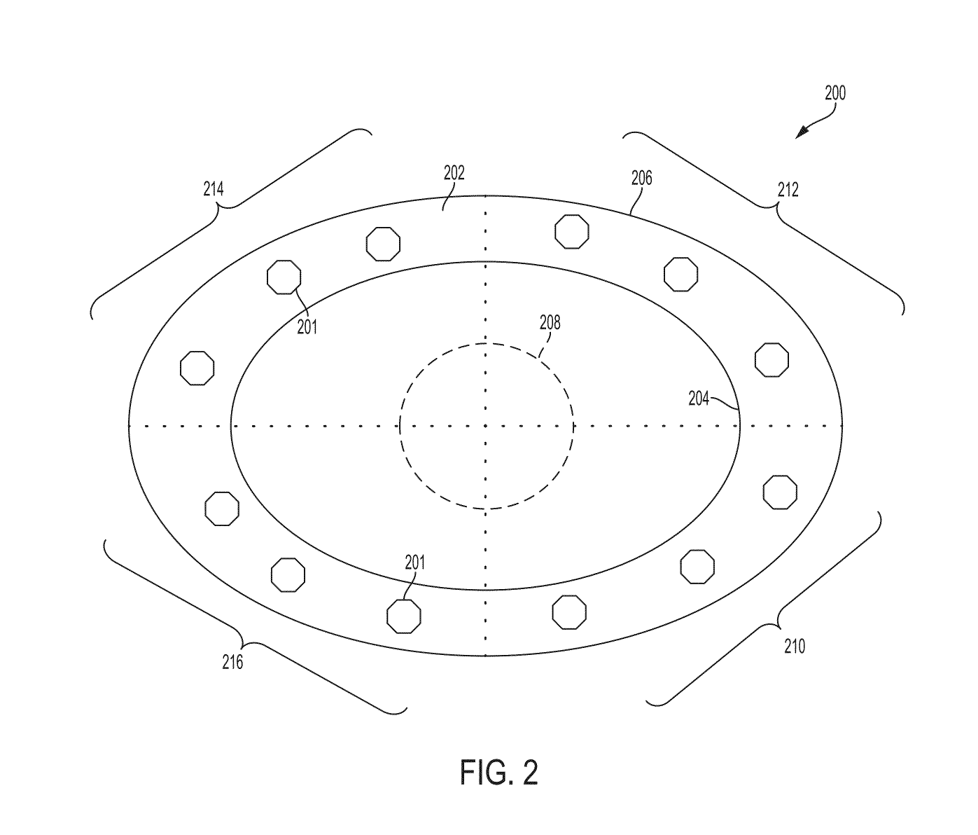

FIG. 2 shows a schematic representation of an elliptical annular illumination structure 200. The elliptical annular ring 202 is defined by an interior circumference 204 and an exterior circumference 206. In aspects, the interior circumference 204 and exterior circumference 206 can be defined as a first and a second circumference, or defined by a first and second pair of diameters, or by a first and a second pair of radii. The light source of the circular annular illumination structure 200 is located in the elliptical annular ring 202, where in some aspects the light sources can be a plurality of LEDs. The elliptical annular ring 202 is centered around a camera 208. Optionally, the visualization cone defined by the aperture of the camera 208 can be illuminated by light sources 201 residing in the elliptical annular ring 202.

The light sources 201 in the elliptical annular ring 202 can be controlled in sections, defined by axes quartering the circular annular illumination structure 200. In aspects, the elliptical annular ring 202 can be divided into a first quadrant 210, a second quadrant 212, a third quadrant 214, and a fourth quadrant 216. The light sources 201 residing in the elliptical annular ring 202 can be independently controlled according to the quadrant in which the light sources 201 are located. Accordingly, in some aspects, light sources 201 in the first quadrant 210 can be set or powered to illuminate while the light sources 201 in the remaining quadrants are turned off and do not illuminate. In other aspects, light sources 201 in the second quadrant 212 can be set or powered to illuminate while the light sources 201 in the remaining quadrants are turned off and do not illuminate. In other aspects, light sources 201 in the third quadrant 214 can be set or powered to illuminate while the light sources 201 in the remaining quadrants are turned off and do not illuminate. In other aspects, light sources 201 in the fourth quadrant 216 can be set or powered to illuminate while the light sources 201 in the remaining quadrants are turned off and do not illuminate. Such aspects allow for the illumination from the elliptical annular ring 202 to be biased from one quadrant of the elliptical annular ring 202.

The yet other aspects, light sources 201 in two quadrants of the elliptical annular ring 202 can be turned on or powered to cast light and illuminate, where two adjacent quadrants that illuminate simultaneously allow for the illumination from the elliptical annular ring 202 to be biased from one half or one side of the elliptical annular ring 202. In some aspects, light sources 201 in the first quadrant 210 and second quadrant 212 can be set or powered to illuminate while the light sources 201 in the remaining quadrants are turned off and do not illuminate. In some aspects, light sources 201 in the first quadrant 210 and fourth quadrant 216 can be set or powered to illuminate while the light sources 201 in the remaining quadrants are turned off and do not illuminate. In some aspects, light sources 201 in the second quadrant 212 and third quadrant 214 can be set or powered to illuminate while the light sources 201 in the remaining quadrants are turned off and do not illuminate. In some aspects, light sources 201 in the third quadrant 214 and fourth quadrant 216 can be set or powered to illuminate while the light sources 201 in the remaining quadrants are turned off and do not illuminate.

In other aspects, three of the four quadrants of light sources 201 in the elliptical annular ring 202 can be illuminated simultaneously. In still other aspects, two opposing quadrants of light sources 201 in the elliptical annular ring 202 can be illuminated simultaneously (e.g. illuminating the second quadrant 212 and the fourth quadrant 216). In further aspects, all four quadrants of light sources 201 in the elliptical annular ring 202 can illuminate simultaneously.

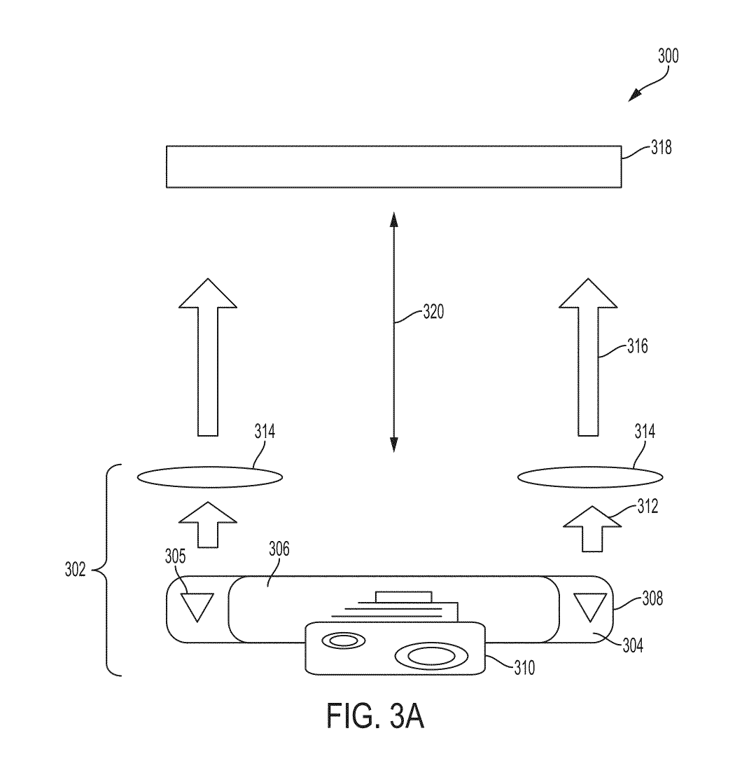

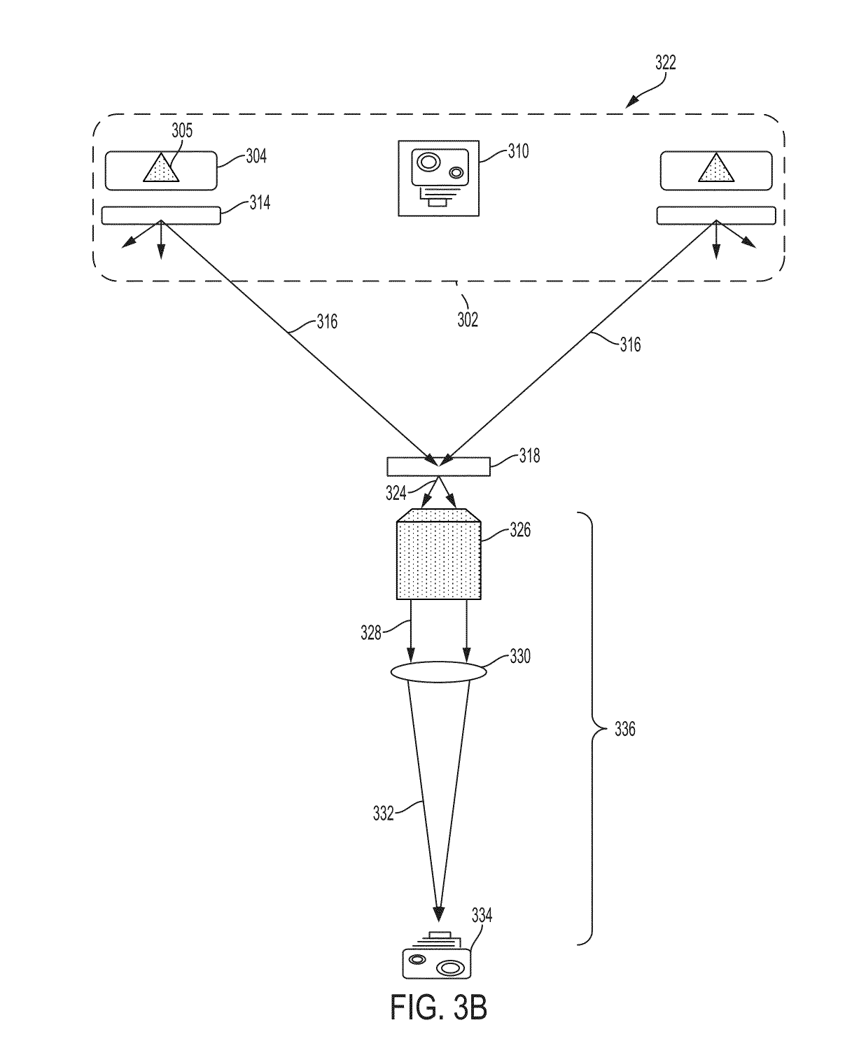

FIG. 3A shows a schematic cross-sectional representation of a microscopy system 300 configured to have an annular illumination structure 302, a diffuser structure 316, and a target region 318. The annular illumination assembly 302 includes an annular ring 304 defined by an internal circumference wall 306 and an external circumference wall 308, having a plurality of light sources 305 disposed in the annular ring 304 and the diffuser structure 314 located proximate to the plurality of light sources 305 in the annular ring 304. In some embodiments, the diffuser structure 314 can be a ring-shaped structure configured to couple with the annular ring 304. In other embodiments, the diffuser structure 314 can be a plurality of diffuser elements located proximate to each light source of the plurality of light sources in the annular ring 304. In such embodiments transmissive light 312 illuminating from the plurality of light sources 305 in the annular ring 304 is incident on the diffuser structure 314. After passing through the diffuser structure 314 the diffuse transmissive light 316 can illuminate the target region 318 in which, or on which, a sample can be located. The diffuse transmissive light 316 can transmit though, refract though, or reflect off of the target region 318 and/or sample, such that target region 318 and/or sample can be viewed by an objective camera of the microscopy system. In some embodiments, an orientation camera 310, directed at the target region 318 can be positioned within the inner diameter of the annular ring 304, which can provide for an efficient and compact structural configuration for the overall microscopy system 300. In aspects, the orientation camera 310 can have a viewing area of about 200 mm, directed to view at least a part of the target region 318.

In aspects, the annular illumination assembly 302 can be located an adjustable z-distance 320 from the target region 318. The adjustable z-distance 320 can be adjusted to increase or decrease the distance, intensity, and/or coverage of the illumination from the annular illumination assembly 302 on the target region 318. In some aspects, the adjustable z-distance 320 can be about 100 mm. In other aspects, the adjustable z-distance 320 can be from about 50 mm to about 150 mm. In some embodiments, as represented in FIG. 3A, the annular illumination assembly 302 can project upward from a position relatively below the target region 318. In other embodiments, as represented in FIG. 3B, the annular illumination assembly 302 can project downward from a position relatively above the target region 318.

FIG. 3B shows a schematic representation of a microscopy system 322 configured to have an annular illumination structure 302, a diffuser structure 314, a target region 318, an objective lens 326, and a microscope camera 334. FIG. 3B expands upon the schematic of FIG. 3A, illustrating the system for capturing the image of a sample in the target region 318 with a microscope camera 334. As described above, the annular ring 304 can hold or house one or more light sources 305, where each light source, or grouping of light sources, can have a diffuser structure 314 proximate to and in the optical path of light emitted by the light sources 305. Optionally, the annular ring 304 can be positioned around an orientation camera 310, which as noted above can provide for an efficient and compact structural configuration for the overall microscopy system 322. The diffuse transmissive light 316 emitted through the diffuser structure 314 is at least in part incident on the target region 318, which can hold a sample. The rays of the diffuse transmissive light 316 are incident on the target region 318 at an angle that is determined by the geometry of the annular ring 304.

The initial image light 324 that passes through the target region 318 continues into the microscope objective lens 326. The microscope objective lens 326 can focus the initial image light 324 rays to produce real image light 328, which in turn can be focused by a tube lens 330 and is directed as focused image light 332 toward the microscope camera 334. The microscope camera 334 can capture the image of the target region 318 and any sample contained therein. In some aspects, the microscope camera 334 can be a CMOS camera sensor. Further, the assembly of the microscope objective lens 326, the tube lens 330, and the microscope camera 334 can be referred to in aggregate as the microscope 336 of the microscopy system 322. In some aspects, the microscope 336 has a viewing area of about 0.75 mm², directed to view at least a part of the target region 318. The annular illumination of any phase objects in the target region 318 by light sources 305 in the annular ring 304 can allow for greater clarity and precision of images captured by the microscope 336, as opposed to other illumination configurations or arrangements known in the art.

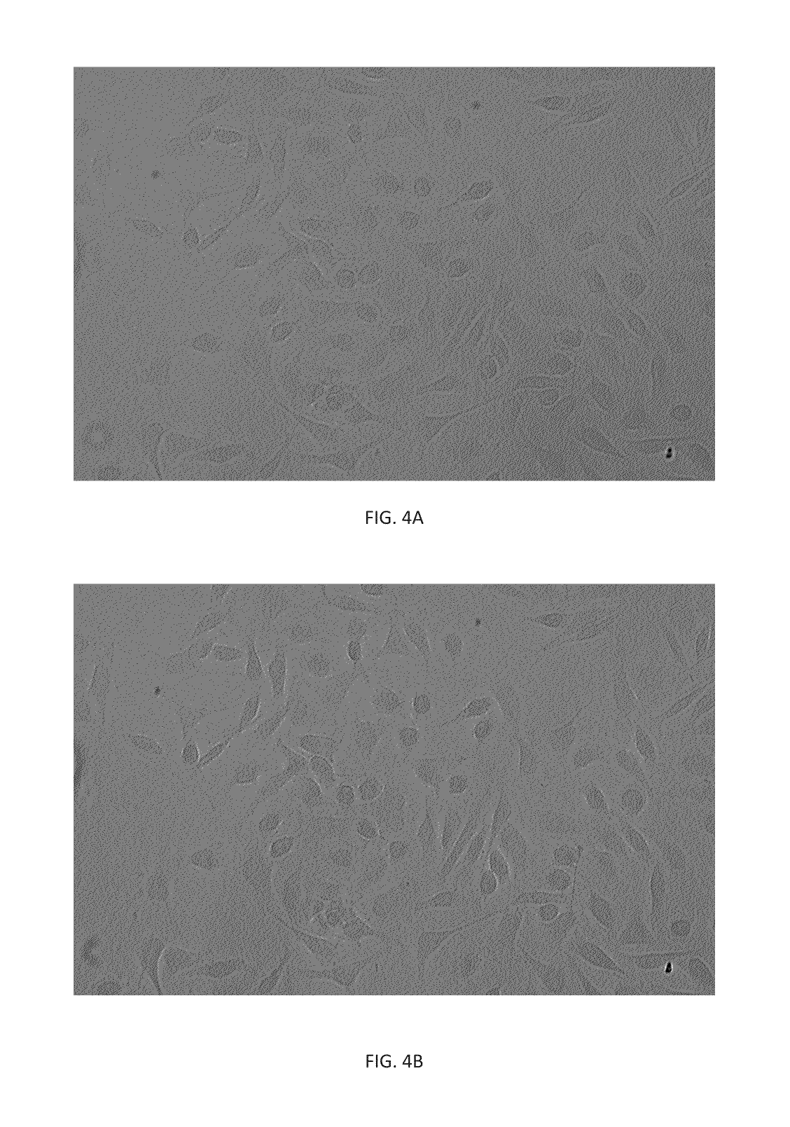

FIG. 4A shows an exemplary image of a sample illuminated by warm white light, presented in comparison with FIG. 4B which shows an exemplary image of a sample illuminated by warm white light biased from the left side of the sample. As shown, both FIG. 4A and FIG. 4B are both images that have been digitally modified according to the same degree of contrast rendering, to further highlight the contrast of the image and objects therein. The comparison of

FIG. 4A and FIG. 4B illustrates that, where both images are illuminated with warm white light, the light incident from a bias on one side of the sample (in this case the left side), results in an image with greater clarity and definition of phase objects viewed.

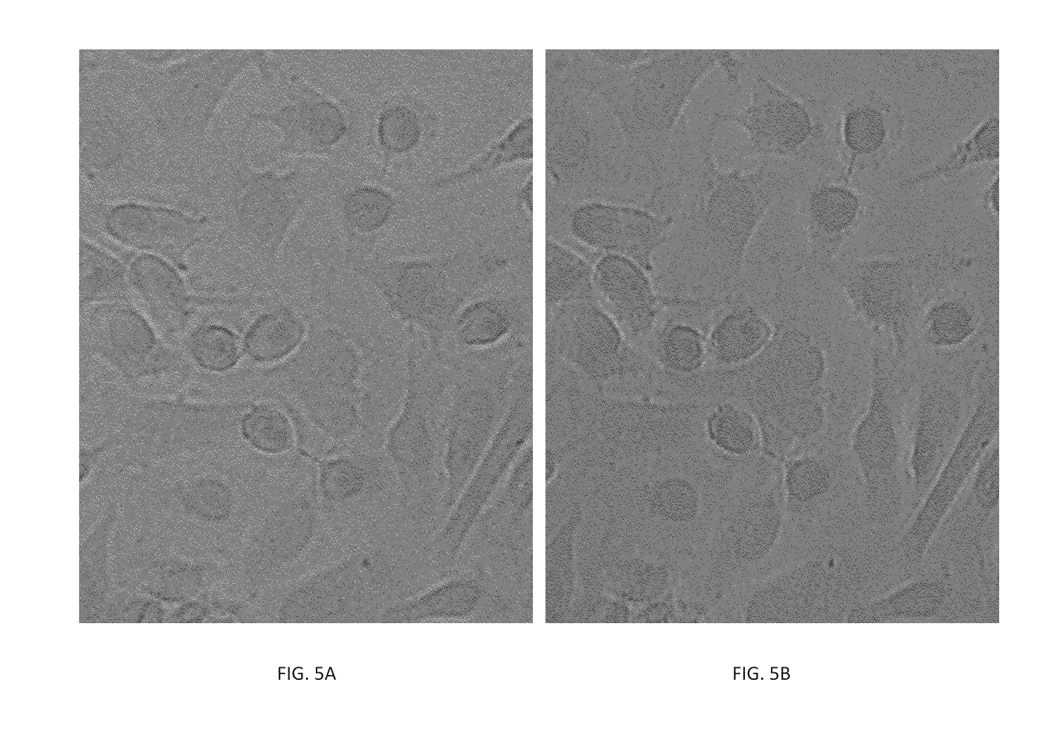

FIG. 5A shows an exemplary zoomed-in image of a sample illuminated by diffuse white light at full illumination, presented in comparison with FIG. 5B which shows an exemplary zoomed-in image of a sample illuminated by diffuse white light biased from the left side of the sample. As shown, both FIG. 5A and FIG. 5B are both images that have been digitally modified according to the contrast rendering, where FIG. 5A has been digitally modified three times according to the contrast rendering and where FIG. 5B has been digitally modified two times according to the contrast rendering. The comparison of FIG. 5A and FIG.

5B illustrates that, where both images are illuminated with warm white light, the light incident from a bias on one side of the sample (in this case the left side), even with less digital contrast modification, results in an image with greater clarity and definition of phase objects viewed.

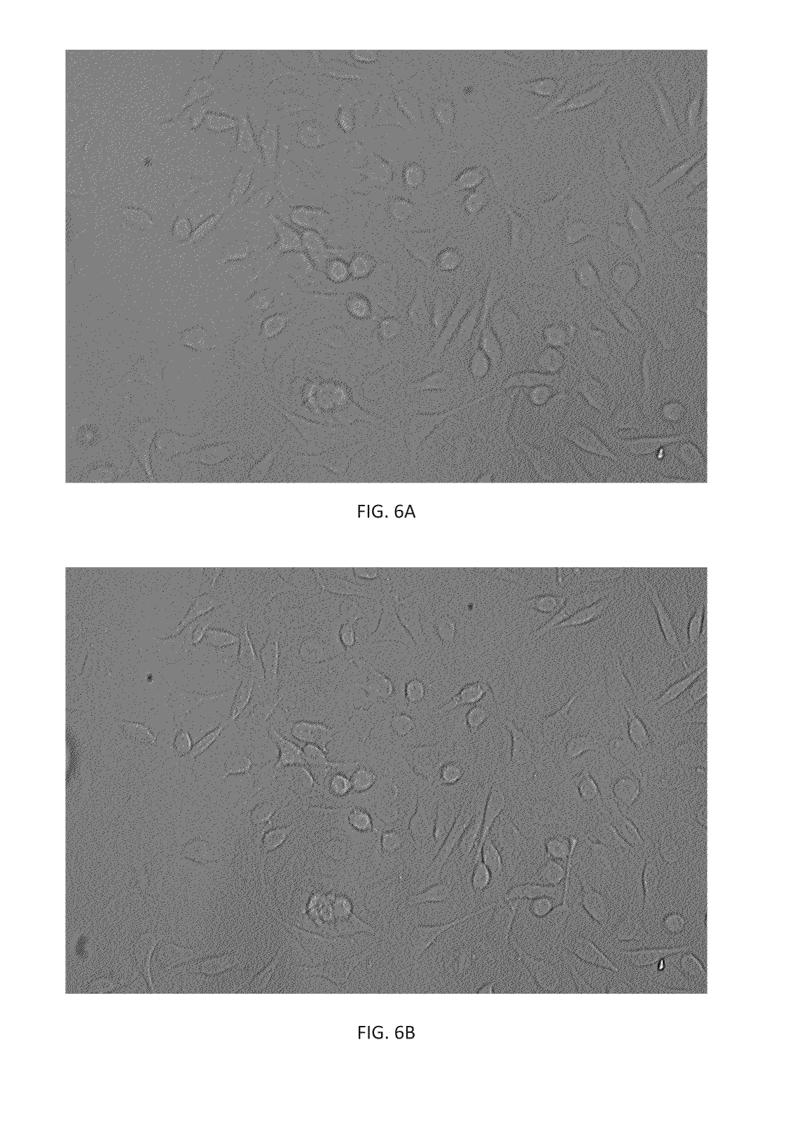

FIG. 6A shows an exemplary image of a sample illuminated by warm white light using a bright focus (in other words, on the bright side of focus), presented in comparison with FIG. 6B which shows an exemplary image of a sample illuminated by warm white light biased from the left side of the sample. The comparison of FIG. 6A and FIG. 6B illustrates that, where both images are illuminated with warm white light, the light incident from a bias on one side of the sample (in this case the left side), results in an image with greater clarity and definition of phase

PATENT objects viewed as compared to an image captured with non-biased light on the bright side of focus.

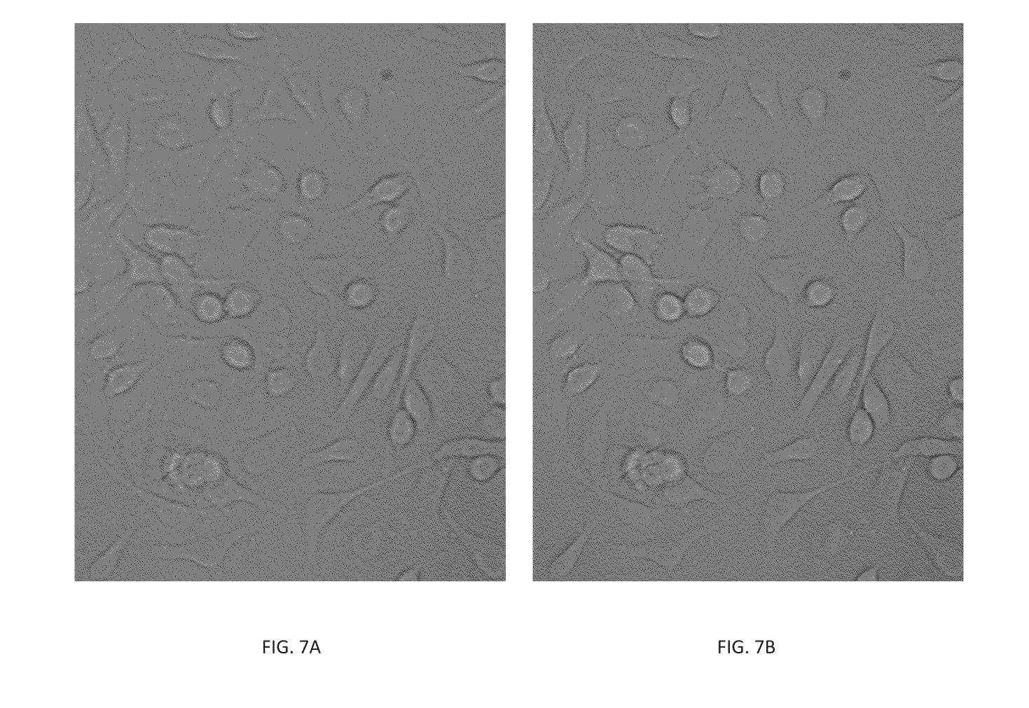

FIG. 7A shows an exemplary image of a sample illuminated by white light, presented in comparison with FIG. 7B which shows an exemplary image of a sample illuminated by green light. The comparison of FIG. 7A and FIG. 7B illustrates that, where one image is illuminated with warm white light and the other image is illuminated with light in the green color wavelength ranges, the image illuminated with green light results in an image with greater clarity and definition of phase objects viewed as compared to an image illuminated with warm white light.

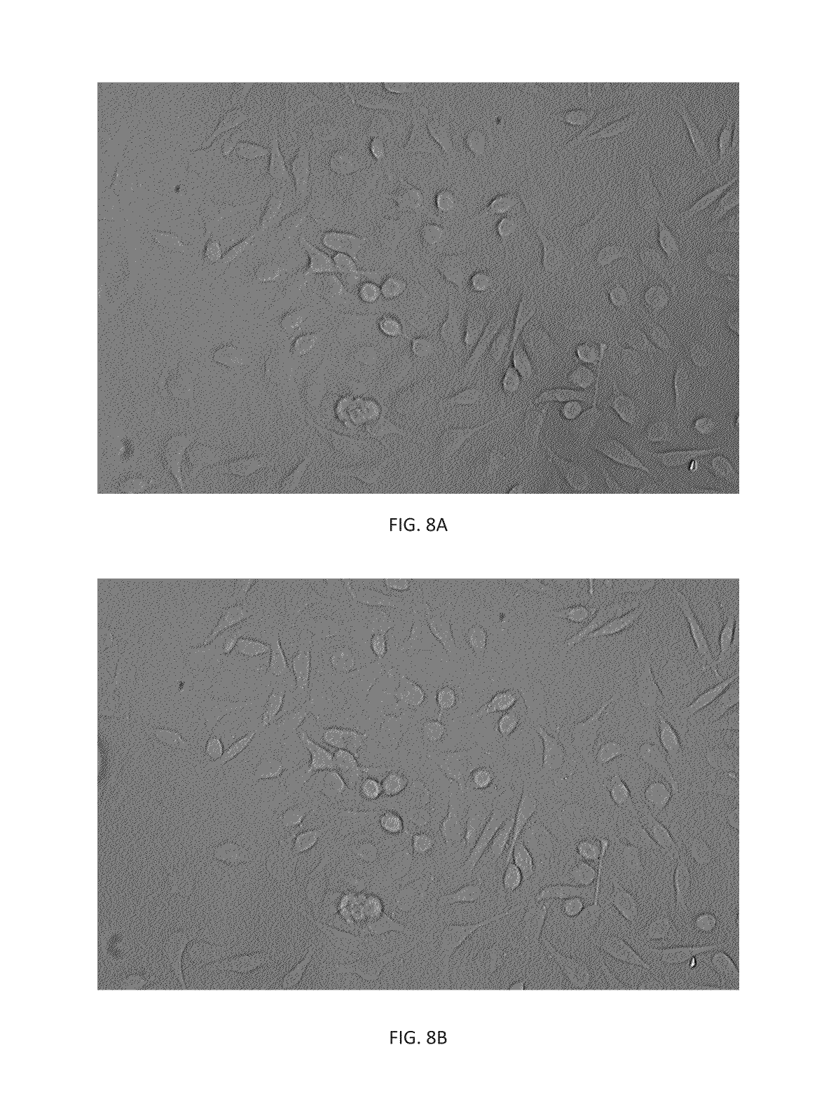

FIG. 8A shows an exemplary image of a sample illuminated by green light biased from the right side of the sample, presented in comparison with FIG. 8B which shows an exemplary image of a sample illuminated by green light biased from the left side of the sample. The comparison of FIG. 8A and FIG. 8B illustrates that, where both images are illuminated with light in the green color wavelength range, the light incident from a bias on the left side of a sample, results in an image with relatively equal clarity and definition of phase objects viewed as compared to an image where the light is incident from a bias on the right side of a sample. The comparison of FIG. 8A and FIG. 8B further illustrates, however, that the combined information from both images can provide a greater amount on information regarding the structure and arrangement of phase objects viewed by both images. While the figure demonstrates superiority of green light to white light, the effect observed can be a result of either or both of the specific light color and the narrow band of wavelengths used. Thus, a similar effect can occur if a different narrow band of wavelengths are used, for example red light or blue light.

As can be seen in FIGS. 4A-8B, specific elements of the presently-disclosed microscopy system, the diffuser structure, the semicircular or quadrant biased illumination, and single color illumination can each, individually or in combination, contribute to imaging of phase objects with greater clarity and precision than other imaging techniques (such as bright field imaging) as known in the art.

With these embodiments in mind, it will be apparent from this description that aspects of the described techniques may be embodied, at least in part, in software, hardware, firmware, or any combination thereof for the control of cameras and light sources that are a part of a microscopy system. It should also be understood that embodiments can employ various computer-implemented functions involving data stored in a data processing system. That is, the techniques may be carried out in a computer or other data processing system in response executing sequences of instructions stored in memory. In various embodiments, hardwired circuitry may be used independently, or in combination with software instructions, to implement these techniques. For instance, the described functionality may be performed by specific hardware components containing hardwired logic for performing operations, or by any combination of custom hardware components and programmed computer components. The techniques described herein are not limited to any specific combination of hardware circuitry and software.

As provided herein, the microscopy instrumentation and annular illumination assembly which can illuminate samples located in a target region can be electronically coupled with an imaging instrumentation interface. Such a microscopy instrumentation system and corresponding imaging instrumentation interface, can be electrically coupled to a microprocessor, (or other such non-transitory, computer-readable mediums) by wires or by wireless means, and thereby send imaging data signals to the microprocessor. The coupled microprocessor can relay instructions to light sources disposed in the annular illumination assembly to cause the light sources to illuminate or to not illuminate as according to received data signals. The coupled microprocessor can further collect imaging data from the imaging apparatus and/or imaging instrumentation interface can further relay collected information to other non-transitory, computer-readable mediums, and/or run calculations on collected data and relay the calculated result to a user-operable and/or user-readable display. The imaging data captured by the imaging apparatus can be evaluated according to computer program instructions controlling the microprocessor (either through hardware or software) to analyze or base calculations on specific wavelengths of light emitted by a sample gel, blot, or membrane, and/or specific wavelengths of light used to illuminate a sample gel, blot, or membrane.

Accordingly, microscopy system instrumentation as described herein can include a microprocessor can further be a component of a processing device that controls operation of the imaging instrumentation. The processing device can be communicatively coupled to a non-volatile memory device via a bus. The non-volatile memory device may include any type of memory device that retains stored information when powered off Non-limiting examples of the memory device include electrically erasable programmable read-only memory (“ROM”), flash memory, or any other type of non-volatile memory. In some aspects, at least some of the memory device can include a non-transitory medium or memory device from which the processing device can read instructions. A non-transitory, computer-readable medium can include electronic, optical, magnetic, or other storage devices capable of providing the processing device with computer-readable instructions or other program code. Non-limiting examples of a non-transitory, computer-readable medium include (but are not limited to) magnetic disk(s), memory chip(s), ROM, random-access memory (“RAM”), an ASIC, a configured processor, optical storage, and/or any other medium from which a computer processor can read instructions. The instructions may include processor-specific instructions generated by a compiler and/or an interpreter from code written in any suitable computer-programming language, including, for example, C, C++, C#, Java, Python, Perl, JavaScript, etc.

The above description is illustrative and is not restrictive, and as it will become apparent to those skilled in the art upon review of the disclosure, that the present invention may be embodied in other specific forms without departing from the essential characteristics thereof. For example, any of the aspects described above may be combined into one or several different configurations, each having a subset of aspects. Further, throughout the foregoing description, for the purposes of explanation, numerous specific details were set forth in order to provide a thorough understanding of the invention. It will be apparent, however, to persons skilled in the art that these embodiments may be practiced without some of these specific details. These other embodiments are intended to be included within the spirit and scope of the present invention. Accordingly, the scope of the invention should, therefore, be determined not with reference to the above description, but instead should be determined with reference to the following and pending claims along with their full scope of legal equivalents.

What is claimed is:

1. An annular light source and microscopy camera assembly comprising:
an annular ring having an interior circumference and an exterior circumference;
at least one light source disposed in the annular ring between the interior circumference and the exterior circumference;
optionally, an orientation camera, positioned within the interior circumference of the annular ring and directed toward a target region;
a diffuser structure, positioned proximate to the at least one light source and between the at least one light source and the target region, such that illumination from the at least one light source passes through the diffuser structure before illuminating the target region; and
a microscopy camera positioned to capture an image of the target region illuminated by light that passes through the diffuser structure.

2. The annular light source and microscopy camera assembly according to claim 1, wherein the at least one light source is a plurality of LEDs.

3. The annular light source and microscopy camera assembly according to claim 2, wherein the plurality of LEDs are warm white LEDs.

4. The annular light source and microscopy camera assembly according to claim 2, wherein the plurality of LEDs are green LEDs.

5. The annular light source and microscopy camera assembly according to claim 1, wherein the microscopy camera is positioned on a side of the target region opposite from the annular ring and the diffuser structure.

6. The annular light source and microscopy camera assembly according to claim 1, wherein the microscopy camera assembly does not include a condenser lens.

7. The annular light source and microscopy camera assembly according to claim 1, wherein the annular ring includes at least one independently controllable light source in each quadrant of the annular ring.

8. The annular light source and microscopy camera assembly according to claim 1, wherein a z-distance between the annular ring and the target region is adjustable.

9. An annular light source and microscopy camera assembly comprising:
an annular ring having an interior circumference and an exterior circumference;
a plurality of LEDs disposed in the annular ring between the interior circumference and the exterior circumference;
an orientation camera, positioned within the interior circumference of the annular ring and directed toward a target region; and
a microscopy camera positioned to capture an image of the target region illuminated by light emitted from the plurality of LEDs.

10. The annular light source and microscopy camera assembly according to claim 9, wherein the plurality of LEDs are warm white LEDs.

11. The annular light source and microscopy camera assembly according to claim 9, wherein the plurality of LEDs are green LEDs.

12. The annular light source and microscopy camera assembly according to claim 9, further comprising a diffuser structure, positioned proximate to the plurality of LEDs and between the plurality of LEDs and the target region, such that illumination from the plurality of LEDs passes through the diffuser structure before illuminating the target region.

13. The annular light source and microscopy camera assembly according to claim 9, wherein the annular ring includes at least one independently controllable LED in each quadrant of the annular ring.

14. The annular light source and microscopy camera assembly according to claim 9, wherein the microscopy camera assembly does not include a condenser lens.

15. The annular light source and microscopy camera assembly according to claim 9, wherein a z-distance between the annular ring and the target region is adjustable.

16. The annular light source and microscopy camera assembly according to claim 9, wherein the microscopy camera is positioned on a side of the target region opposite from the annular ring.

17. A method of illuminating a target region in a microscopy camera assembly comprising:
providing an annular structure, having a plurality of light sources disposed between an interior circumference and an exterior circumference of the annular structure, proximate to the target region;
instructing at least one of the plurality of light sources to illuminate; and
transmitting light through a diffuser structure onto the target region.

18. The method of claim 17, further wherein the plurality of light sources are individually controllable within each quadrant of the annular structure and instructing at least one of the plurality of light sources to illuminate further comprises instructing only one quadrant of the plurality of light sources to illuminate.

19. The method of claim 17, further wherein the plurality of light sources are individually controllable within each quadrant of the annular structure and instructing at least one of the plurality of light sources to illuminate further comprises instructing two adjacent quadrants of the plurality of light sources to illuminate.

20. The method of claim 17, further comprising adjusting a z-distance between the annular structure and the target region.

21. The method of claim 17, wherein light emitted from the plurality of light sources is biased to emit from light sources on one side of the annular structure.

22. The method of claim 17, wherein light emitted from the plurality of light sources is of a narrow band of wavelengths.

23. The method of claim 17, wherein light emitted from the plurality of light sources is biased to emit from light sources on one side of the annular structure and is of a narrow band of wavelengths.
